(19) United States
(12) Patent Application Publication
(10) Pub. No.: US 2014/0163759 A1
(43) Pub. Date: Jun. 12, 2014

(54) DIGITAL BUILDING OPERATING SYSTEM WITH AUTOMATED BUILDING AND ELECTRIC GRID MONITORING, FORECASTING, AND ALARM SYSTEMS

(71) Applicant: THE TRUSTEES OF COLUMBIA UNIVERSITY IN THE CITY OF NEW YORK, New York, NY (US)

(72) Inventors: Roger N. ANDERSON, New York, NY (US); Arthur A. KRESSNER, Westfield, NJ (US); John J. GILBERT, III, New Rochelle, NY (US); Eugene M. BONIBERGER, West Islip, NY (US)

(73) Assignee: THE TRUSTEES OF COLUMBIA UNIVERSITY IN THE CITY OF NEW YORK, New York, NY (US)

(21) Appl. No.: 14/137,381

(22) Filed: Dec. 20, 2013

Related U.S. Application Data
(63) Continuation-in-part of application No. 12/909,022, filed on Oct. 21, 2010, now abandoned.
(60) Provisional application No. 61/745,175, filed on Dec. 21, 2012.
(60) Provisional application No. 61/256,675, filed on Oct. 30, 2009.

(51) Int. Cl. G06Q 50/06

(52) U.S. Cl. CPC G06Q 50/06
USPC 700/291

(57) ABSTRACT

A system and method for monitoring status of an electrical grid and one or more building subsystems. The system includes sensors in communication with an electrical grid, buildings that provide data related to the building subsystems, and a digital building operating system that includes a processor that performs instructions to process the data, identify the status of the electrical grid and the building subsystem, predict one or more events based on the data, and provide recommendations to the buildings such as how to prevent the bad event.

### CROSS-REFERENCE TO RELATED APPLICATIONS

This application claims priority from U.S. Provisional Application Ser. No. 61/745,175, filed Dec. 21, 2012 and U.S. patent application Ser. No. 12/909,022 filed Oct. 21, 2010, which claims priority U.S. Provisional Application Ser. No. 61/256,675, filed Oct. 30, 2009, which are incorporated herein by reference in their entirety.

### FIELD

The presently disclosed subject matter relates to techniques for monitoring of the operational status of an electrical distribution grid and other vital functions of the lower voltage end-user facility.

### BACKGROUND

While the distribution grid can operate at a high level of reliability, due to the complexity and interconnectedness of the grid, events such as, for example, power failures, blackouts or low voltage and frequency brownouts, or the like occasionally occur. Such events can be precipitated, for example, by issues in adjoining regions, or by excess demand that surpasses the available delivery capacity of the grid. In either case, when power quality is lost to the end-user consumers, the equipment and building systems, and especially computer systems relied upon by the consumers can cease to function. For example, where the end-user consumer is a multistory office building, the sudden loss of power could result in passengers being stranded in elevators that traverse many floors between stops. The location and safety of passengers then becomes problematic, especially in long duration events caused by mega storms or transmission grid failures.

As seen during the Northeastern United States Blackout of 2003 and the Long Island City, N.Y., blackout of 2006, current systems are unable to predict grid supply instability and impending electrical blackouts and brownouts and integrate them with real-time customer power quality measurements and digital building operating systems.

### SUMMARY

Disclosed herein are techniques for real-time monitoring of the operational status of an electrical grid, using low-voltage end-user sensors.

In one aspect of the disclosed subject matter, techniques for monitoring the operational status of an electrical grid include receiving sensor measurements from the electrical power network and one or more buildings, processing the data, identifying the status of the electrical grid based on the data, predicting one or more events based on the data, and providing instructions to the one or more buildings based on the status of the electrical grid and the prediction of one or more events.

In another aspect of the disclosed subject matter the the one or more sensors are low-voltage end-user side of a secondary distribution network. In certain aspects, the data includes one or more of frequency, phase angle, and voltage. The data can also be representative of geographically distributed customers in one or more locations. In certain embodiments, the predicting of the one or more events further includes one or more of instability of the electrical grid, blackout, power failures, and blackouts or low voltage and frequency brownouts. In one or more embodiments, the predicting of the one or more events further includes identifying the location of the grid instability. The system can identify the location of the grid instability using one or more triangulation techniques. The system can use mathematical and statistical techniques such as machine learning and adaptive stochastic control. In certain embodiments, the digital building operating system can provide one or more actions based on the status of the electrical grid.

In one aspect of the disclosed subject matter, the instructions further cause the processor to perform: monitoring the status of the one or more buildings; identifying one or more events in the the one more buildings; determining if the event is related to the electrical grid or the one or more buildings; and providing instructions to the one or more building based on the determination.

In one aspect of the disclosed subject matter, the system can include a plurality of building subsystems, at least one relational database, a control center, a display, and a controller. In one aspect of the disclosed subject matter, the controller can further include a processor that responsive to executable computer instructions when executed on said processor for: monitoring the status of the electrical grid based on data from said plurality of building subsystems and said at least one relational database; predicting one or more events based on data from said plurality of building subsystems and said at least one relational database; providing instructions based on the monitoring of the status of the electrical grid and the prediction of one or more events; and displaying a graphical representation on said display indicating one or more of a consumption level of energy of at least one of said plurality of building subsystems, and a status of one of said plurality of building subsystems.

### BRIEF DESCRIPTION OF THE DRAWINGS

FIG. 1A illustrates an exemplary embodiment of an electrical power network in accordance with one aspect of the disclosed subject matter.

FIG. 1B illustrates an exemplary schematic illustration of an interconnected communications system for the electric power network of FIG. 1A in accordance with one aspect of the disclosed subject matter.

FIG. 2 graphically depicts an example of the digital building operating system in accordance with the disclosed subject matter.

FIG. 3 illustrates an exemplary logic diagram of simultaneous monitoring and prediction performed by the digital building operating system in accordance with the disclosed subject matter.

FIG. 4, FIG. 5, FIG. 6A, FIG. 6B, FIG. 7, and FIG. 8 illustrate exemplary displays for the digital building operating system in accordance with the disclosed subject matter.

FIG. 9 illustrates an exemplary display when an event is detected by the machine learning system of the digital building operating system in accordance with the disclosed subject matter.

FIG. 10 illustrates an exemplary display when an electrical power quality problem is detected by the digital building operating system in accordance with the disclosed subject matter.

FIG. 11 illustrates an exemplary system embodiment having multiple buildings or multiple properties in accordance with the disclosed subject matter.

FIG. 12 illustrates an exemplary electric power quality measurement in accordance with the disclosed subject matter.

### DETAILED DESCRIPTION

The electrical grid is a large, complex system of interconnected elements that tie high power producers, such as a power generation plant for example, with low power consumers. Events such as, for example, power failures, blackouts or low voltage and frequency brownouts, or the like occasionally occur. A method for predicting grid supply instability and impending electrical blackouts that can provide, for example, warning of a failure event is provided herein.

As described in more detail, the following disclosed embodiments relates to predicting grid supply instability and impending events such as blackouts, power failures, or the like. It should be understood that the electrical grid can also be known as the electrical power distribution grid. The following disclosed embodiments also relate to integrating grid supply instability and impending electrical blackouts with real-time customer power quality measurements and digital building operating systems. With sufficient warning, for example, from the utility of a system outage or other failure event, a building operating system can take certain remedial actions such as automatically landing elevators on the next available floor without consultation with the building digital building operating system, owner, manager, utility or other concerned human interfaces.

Certain techniques, such as those disclosed in U.S. patent application Ser. No. 12/909,022 (Published as U.S. Publication No. 2011/0264276), which is hereby incorporated by reference in its entirety, can provide advanced warning to consumers based on measurements from sensors wholly within the electrical, building management system, fire, security, and occupancy networks of the property. For example, sensor measurements can detect a power quality instability event that can be sent to a building operating system, at which time the building operating system can take remedial safety actions. For example, sufficient warning, for example, on the order of +/−30 seconds, can be provided and can indicate the likelihood of a regional system outage that, for example, would interrupt power and result in a blackout. Measurements that indicate this impending grid instability can include frequency, voltage and phase disturbances relative to the norm. Tenants or end-users can be made aware of the problem using a tenant fractal of the building operating system which can notify them via warning signals distributed within their properties to improve the safety of their personnel and protect and safeguard their equipment and systems.

However, such techniques currently only involve the use of sensors located within the electrical utility grid at nodes controlled by a local utility and/or Independent System Operator (for example, at upstream, high-voltage, points in the distribution and/or transmission networks). Experience has shown that notification of impending failure or disruption to customers rarely if ever occurs. Accordingly, the embodiments described herein provide an indication of an outage, disruption, or other failure event in the transmission, distribution or dissemination of local building systems using sensors located downstream of transformers and meters owned by the utility and all other outside service providers such as steam, natural gas, water, sewage, or the like, and such can be useful for saving lives and preserving the wellbeing of tenants of such facilities.

Commercial buildings often have a variety of subsystems that assist the building operator or manager in maintaining the proper functioning of their building. These subsystems can include, but are not limited to, digital building operating systems, Heating, Ventilation, and Air Conditioning (HVAC), fire alarm and communications, security, elevator digital building operating systems, or the like. Typically, the suppliers of the subsystem provide the operator with some type of control interface that allows the building manager to interact with the subsystem, control aspects of its operation and assess its status. In some cases the interface can be a simple dashboard panel having a set of indicators that is proprietary to each subsystem provider. In other cases, the interface can be a dedicated cockpit or software run on a general-purpose computer, such as a building digital building operating system. However, these systems are typically not connected to other critical subsystems such as the electors, security, fire, and occupancy systems, or the like. As such, these proprietary subsystem control systems can require the building manager to actively seek out the information of each subsystem individually. Furthermore, these systems can also, for example, not easily allow the building manager to share the information with their tenants.

One of the larger expenses in the operation of any commercial building, manufacturing facility, microgrid, campus, or military base is typically the heating and air conditioning of the aggregate space. In a typical high rise type commercial building, for example, it can cost the building owner or manager $500-$3000 per hour to operate during the business day. Accordingly, while existing digital building operating systems are adequate for their intended purposes, there remains a need for overall system improvements particularly in the integration and dissemination of all building information systems that are critical to the comfort of occupants, and particularly, to their safety during life-and-limb threatening events.

Thus, a need exists for distribution facilities to provide the situational awareness and machine learning forecasting and prediction of events. A need also exists for distribution facilities capable of providing forecasting of events so that remedial action can be taken to alleviate the threats.

The following disclosed embodiments herein relate to techniques for real-time monitoring, forecasting and optimization of the operational status of an electrical grid, residential condominium, commercial office building, microgrid, campus of buildings such as a university and/or military bases using only low-voltage, end-user sensors such as the building digital building operating systems, elevator, fire, occupancy, security, and energy digital building operating systems. The embodiments described herein can also relate to the electric distribution grid connected to consumers by one or more transformers and electric billing meters.

The embodiments described herein can be designed “from the engine room out” of such facilities to provide the situational awareness and machine learning forecasting and prediction of impending bad events so that remedial action can be taken computer-to-computer to alleviate the threats.

### Exemplary Electric Power Network

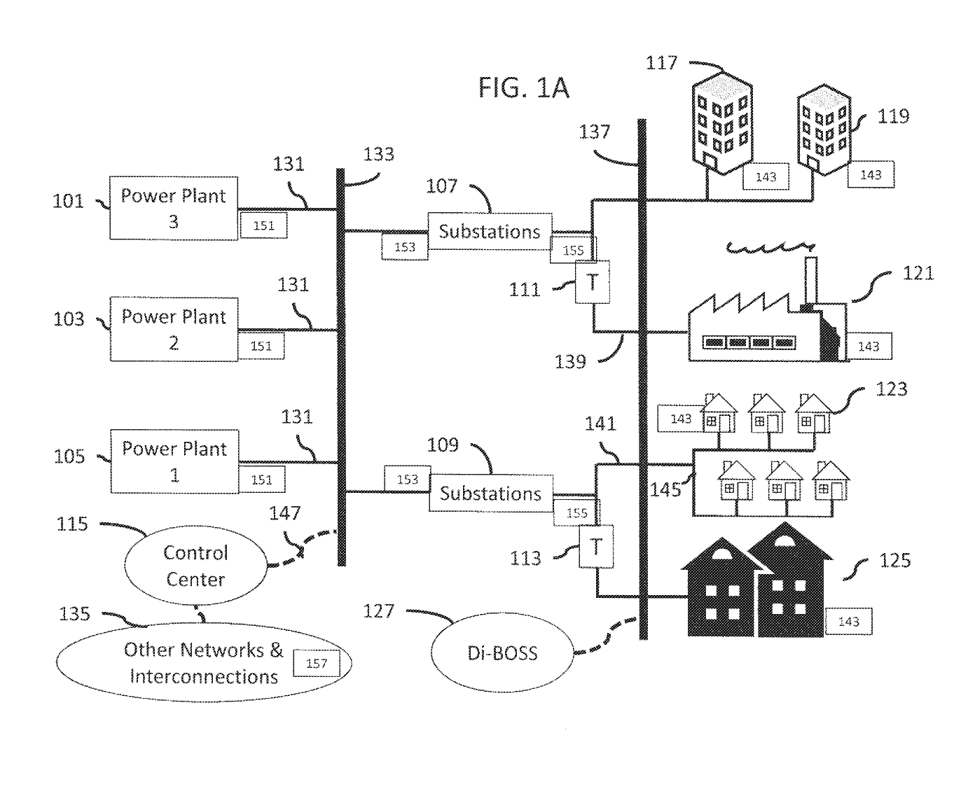

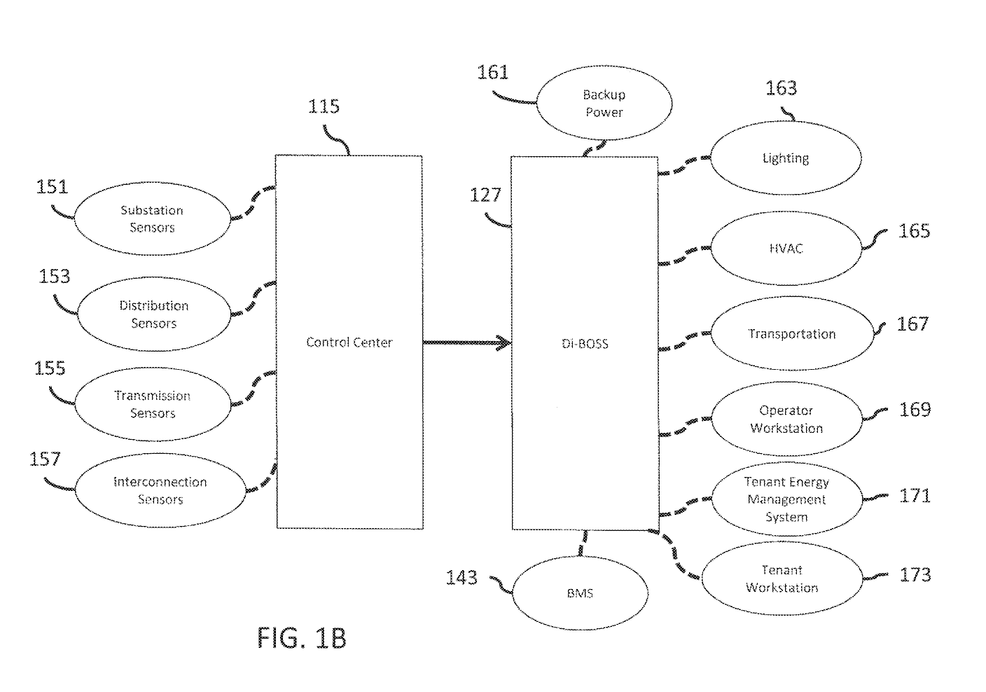

FIG. 1A illustrates an exemplary embodiment of an electrical power network. The electrical power network includes one or more power plants 101, 103, 105 connected in parallel to a transmission network 131 that delivers electrical power to the main distribution network 133. The power plants 101, 103, 105 can include, but are not limited to: coal, nuclear, natural gas, or incineration power plants. Additionally, the power plants 101, 103, 105 can include one or more hydroelectric, solar, or wind turbine power plants. It should be appreciated that additional components including transformers, switchgear, fuses and the like can be incorporated into the electrical power network as needed to ensure the efficient operation of the system. The electrical power network can be interconnected with one or more other regional networks via interconnection 135 to allow the transfer of electrical power into or out of the electrical power network.

The main distribution network 133 typically consists of medium voltage power lines, less than 50 kV for example, and associated distribution equipment which carry the electrical power from the point of production at the power plants 101, 103, 105 to the end users located on local electrical distribution networks 139, 141. The local electrical distribution networks 137 are connected to the main distribution network 133 by substations 107, 109 that adapt the electrical characteristics of the electrical power to those needed by the end users. Substations 107, 109 typically contain one or more transformers 111, 113, switching, protection, and control equipment. Larger substations 107, 109 can also include circuit breakers to interrupt faults such as short circuits or over-load currents that can occur. Substations 107, 109 can also include equipment such as fuses, surge protection, controls, meters, capacitors and voltage regulators. It should be appreciated that the representations of the substations 107, 109 is for illustration purposes and the electrical power network can have additional substations as needed to deliver the electrical power.

The substations 107, 109 connect to one or more local electrical distribution networks, such as local electrical distribution network 139, for example, that provides electrical power to a commercial area having end users such as an office building 117, 119, a manufacturing facility 121, or a university campus 125. As will be discussed in more detail below, these commercial buildings can have a building management system 143 that controls various subsystems within the office building 117, 119, a manufacturing facility 121, or a university campus 125. Local electrical distribution network 139, 141 can also include one or more transformers 111, 113 that further adapt the electrical characteristics of the delivered electricity to the needs of the end users. Substation 107, 109 can also connect with other types of local distribution networks such as residential electrical distribution network 123. The residential electrical distribution network 141 can include one or more residential buildings 123 and also light industrial or commercial operations. Similar to the commercial buildings, the residential buildings can also have a building management system (BMS) 143 to assist them in understanding and controlling their electrical usage.

An exemplary electric power network can include a “low-voltage end-user side” 137 of electrical distribution networks 139, 141. As used herein, the term “low-voltage end-user side” can refer to a portion of a distribution network owned and/or controlled by a customer, without regard to the actual voltage. That is, for example, power utilities can generate electrical power at remote plants 101, 103, 105 and deliver electricity to residential, business and/or industrial customers 117, 119, 121, 123, 125 via transmission networks and distribution grids. Power can be transmitted as high voltage transmissions 133 from the remote power plants 101, 103, 105 to geographically diverse substations 107, 109. From the substations 107, 109, the received power can be transformed to lower voltages using cables or “feeders” to local transformers 111, 113 that further reduce the voltage 137 and deliver the electricity to the low voltage end-user owned equipment that can be tapped directly by the customers. A digital building operating system can be connected to the system to monitor and analyze the electric power, energy consumption, or the like in the low-voltage end-user side 137 of the electric power network.

In an exemplary embodiment, the electrical power available to an end user on one of the local electrical distribution networks 139, 141 will depend on number of factors including the generation capacity of power plants 101, 103, 105, the operational status of interconnection 135 and transmission network 131, the characteristics of local distribution network and the location of the end user on the local network. For example, local electrical distribution network 139, 141 can include one or more transformers 111, 113 that further divides local electrical distribution network 141 into two sub-networks 145. One such electrical characteristic is the maximum power that can be delivered to a local distribution network. While the electrical power network can have power plants 101, 103, 105 capable of generating many megawatts of electrical power, this power cannot be completely available to an end user in a residence 123 on a local electrical distribution network 141 since the intervening equipment and cabling restrictions, or limits the delivery of electrical power.

Certain customers can be provided with power at higher voltages relative to those customers receiving normal electric service. For example, “high-tension” customers can receive an intermediate voltage level of service, and can operate customer-controlled transformer to provide a customer-controlled low-voltage power distribution network. Accordingly, as used herein, the term “low-voltage” can refer to either the normal electric service, or to the intermediate voltage service, including customer-controlled transformers 111, 113 or power distribution networks 139, 141.

### Exemplary Control Center

The flow of electrical power within the electrical power network is controlled by one or more network control centers 115. The control centers can be based on machine learning (ML) systems. It should be appreciated that while a single control center 115 is illustrated, the electrical power network can include a plurality of control centers that are interconnected and cooperate to deliver electrical power to the end consumer.

The control center 115 can include one or more processing systems. The processing system has one or more central processing units (processors). Processors are coupled to system memory and various other components via a system bus. Read only memory (ROM) is coupled to the system bus and can include a basic input/output system (BIOS), which controls certain basic functions of processing system. The processing system can further include an input/output (I/O) adapter and a network adapter coupled to the system bus. I/O adapter can be a small computer system interface (SCSI) adapter that communicates with a hard disk and/or tape storage drive or any other similar component. A network adapter interconnects the system bus with communication network 147 enabling processing system to communicate with other such systems, such as building management system 143. One or more screens (e.g., a display monitor) are connected to the system bus by a display adaptor. Additional input/output devices can be connected to the system bus via user interface adapter and a display adapter. A keyboard, mouse, and speaker are all interconnected to the bus.

It will be appreciated that the processing system can be any suitable computer or computing platform, and can include a terminal, wireless device, information appliance, device, workstation, mini-computer, mainframe computer, personal digital assistant (PDA) or other computing device. It shall be understood that the processing system can include multiple computing devices linked together by a communication network. For example, there can exist a client-server relationship between two systems and processing can be split between the two.

### Exemplary Digital Building Operating System

FIG. 1B illustrates an exemplary schematic illustration of an interconnected communications system for the electric power network of FIG. 1A. As illustrated in FIG. 1B, a digital building operating system (Di-BOSS) 127 can be in communication with the control center 115, and the Di-BOSS 127 can be adapted to receive one or more signals from the control center 115. The control center 115 can monitor the electric power network as described in U.S. patent application Ser. No. 12/909,022, which is incorporated herein by reference in its entirety.

It should be appreciated that while a single Di-BOSS 127 is illustrated herein, this is for exemplary purposes and the disclosed subject matter should not be so limited. The Di-BOSS 127 can also include several systems, or can control multiple buildings or facilities for example.

In an exemplary embodiment, Di-BOSS 127 can provide a building owner a centralized control platform for the various subsystems within a building, such as a commercial office building 117, 119 for example. It should be understood that these systems can also be known as tenant subsystems or building subsystems. These subsystems can include but are not limited to, backup power generation systems 161, lighting systems 163, heating, ventilation and air conditioning systems (HVAC) 165, transportation systems 167 (e.g. escalators and elevators), and a tenant energy management system 171. The Di-BOSS can also communicate with the BMS 143. The Di-BOSS 127 can further be arranged to communicate with an operator workstation 169 and a tenant workstation 173. The operator workstation 169 and tenant workstation 173 provide an interface for the building manager and the tenant respectively. The operator workstation 169 and tenant workstation 173 can be any suitable computer or computing platform, and can include a terminal, wireless device, information appliance, device, workstation, mini-computer, mainframe computer, personal digital assistant (PDA), cellular phone, or other computing device. In one embodiment, the Di-BOSS 127 is further configured to communicate with a wireless device, such as a cellular phone for example.

The Di-BOSS 127 also includes a processing system having one or more central processing units (processors). Processors are coupled to system memory and various other components via a system bus in a similar manner to that described above with respect to processing system. It should be appreciated that building management system can be any suitable computer or computing platform, and can include a terminal, wireless device, information appliance, device, workstation, mini-computer, mainframe computer, personal digital assistant (PDA), cellular phone, or other computing device.

In the exemplary embodiment, the Di-BOSS 127 can include a supervisor control and data acquisition system (SCADA) 225 capable to altering the operation of the subsystems 161, 163, 165, 167, 169, 171, 173 to meet desired performance characteristics. For example, the Di-BOSS 127 can be coupled to thermostats to allow an automatic change in temperature. This could allow the Di-BOSS 127 to reduce energy consumption by increasing the temperature by a few degrees during the summer such that the air conditioning system is not operated as often.

The control center 115 is coupled to transmit signals to the Di-BOSS 127 via communication network. This interconnection of the control center 115 and Di-BOSS 127 allow the electrical power network and buildings 117, 119, 121, 123, 125 to cooperate in response to anticipated electrical network events. Advantages can be gained by initiating corrective actions prior to the electrical network event to either eliminate the event (e.g. lower demand) or reducing its impact (e.g. stopping elevators at the closest floor).

In an exemplary embodiment, the control center 115 is connected to sensors 151, 153, 155, and 157 that allow the control center 115 to monitor the real-time operation of the electrical power network. A control center 115 can monitor the sensor data, and can process the sensor data to identify a condition indicative of network instability. For example, the control center 115 can include a conventional analytical description or engineering model such as a Power Flow Model, and/or a Machine Learning module or other pattern recognition detection system, which can be adapted to identify a pattern in the sensor data that is associated with a failure event and issue alarms as further described herein. The control center 115 can generate a metric (for example, a probability metric) related to the prediction of that the detected anomaly or anomalies is about to result in an imminent failure event. Additionally or alternatively, the control center 115 can generate a recommended action to ameliorate or remedy an impending failure event.

In an exemplary embodiment, the control center 115 is connected to sensors. The sensors can include generation and transmission sensors 155, substation sensors 151, local distribution sensors 153 and interconnection sensors 157. These sensors 151, 153, 155, 157 include, but are not limited to phasor measurement units (PMU), power demand meters, voltage meters, thermocouples, phase angle meters, current meters and the like. The sensors 151, 153, 155, 157 are coupled to the control center 115 by any known communication network, including but not limited to a wide area network (WAN), a public switched telephone network (PSTN) a local area network (LAN), a global network (e.g. Internet), a virtual private network (VPN), and an intranet. The communication network can be implemented using a wireless network or any kind of physical network implementation known in the art. The sensors can be coupled to the control center 115 through multiple networks (e.g., intranet and Internet) so that not all sensors are coupled through the same network. Furthermore, the sensors can be connected to the control center 115 by a combination of a PSTN and the Internet, for example. One or more sensors and the control center 115 can be connected to the communication network in a wireless fashion. The communication network also further connects the control center 115 to the digital building operating system Di-BOSS 127. Sensors can also be connected to the buildings and provide data to Di-BOSS 127 such as data about the building subsystems, the status of electrical or other energy transmissions to the building, or the like.

In certain embodiments, any and/or all of such sensor types located at multiple locations can be connected to the computational control center 115, such as a Machine Learning System or a Di-BOSS 127 that can detect electrical grid instabilities and predict whether the likely outcome is a power outage, a brown out, or a momentary service outage that produces short disturbances such as flickering lights. In connection with the disclosed subject matter, one of ordinary skill in the art will appreciate that certain sensor types can be particularly well suited for a particular location. For example, at the low-voltage end-user side of a distribution network where a customer receives normal electric service, a PQ or sub-meter type sensor can provide monitoring measurements at relatively low cost. Alternatively, for example, a phasor type sensor can be at placed at multiple locations for a customer owning an intermediate level of service.

In another exemplary embodiment, the digital building operating system Di-BOSS 127 can receive sensor data from the control center 115. A Di-BOSS 127 can monitor the sensor data, and can process the sensor data to identify a condition indicative of network instability. For example, the Di-BOSS 127 can include a conventional analytical description or engineering model such as a Power Flow Model, and/or a Machine Learning module or other pattern recognition detection system, which can be adapted to identify a pattern in the sensor data that is associated with a failure event and issue alarms as further described herein. The Di-BOSS 127 can generate a metric (for example, a probability metric) related to the prediction of that the detected anomaly or anomalies is about to result in an imminent failure event. Additionally or alternatively, the Di-BOSS 127 can generate a recommended action to ameliorate or remedy an impending failure event.

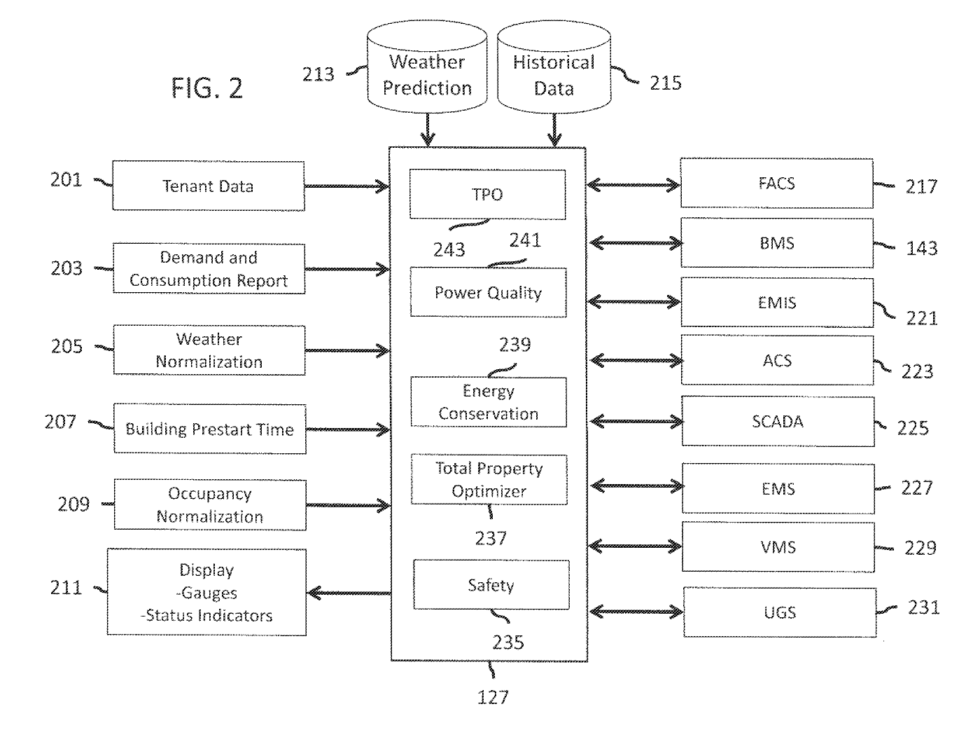

FIG. 2 graphically depicts an example Di-BOSS system 127. In an exemplary embodiment, the Di-BOSS 127 can receive subsystem inputs from building subsystems and also external inputs. As will be discussed in more detail below, these inputs can be aggregated and correlated with historical data to provide the building manager with a status for the building with respect to an expected performance. The subsystem inputs include, but are not limited to, a fire alarm and communications system (FACS) 217, a building management system (BMS) 143, an elevator management and information system (EMIS) 221, an occupancy access control system (ACS) 223, a supervisory control and data acquisition system (SCADA) 225, an energy management system (EMS) 227, and a visitor management system (VMS) 229. As used herein, the BMS 143 refers to a system that allows the building manager to adjust the heating, ventilation and air conditioning (HVAC) 165 settings within the building. The HVAC 165 set points can be automatically adjusted by the BMS 143 or controlled manually by the building manager. In response to these inputs the digital building operating system Di-BOSS 127 can provide a machine learning derived forecast of outputs, including a display and operational outputs. It should be appreciated that as used herein, the term building manager or building owner can be used interchangeably to denote the person(s) or entity responsible for the operation of the building, campus, military base, or the like.

In an exemplary embodiment, the various units in communication with the digital building operating system Di-BOSS 127 can transmit and receive signals over a communications medium. The communications medium can be any known communication medium, including but not limited to a wide area network (WAN), a public switched telephone network (PSTN) a local area network (LAN), a global network (e.g. Internet and cloud), a virtual private network (VPN), and an intranet. The communications network can be implemented using a wireless network or any kind of physical network implementation known in the art. Aspects of digital building operating system can be coupled to the property management cockpit through multiple networks (e.g., intranet and Internet) so that not all portions of the digital building operating system are coupled through the same network. Furthermore, the some portions of digital building operating system can be connected to the property management cockpit by a combination of a PSTN and the Internet, for example. One or more portions of digital building operating system can be connected to the communications medium in a wireless fashion.

It will be appreciated that the digital building operating system Di-BOSS can be any suitable computer or computing platform, and can include a terminal, wireless device, information appliance, device, workstation, mini-computer, mainframe computer, personal digital assistant (PDA) or other computing device. It should be understood that the tenant management cockpit can include multiple computing devices linked together by a communication network. For example, there can exist a client-server relationship between two systems and processing can be split between the two.

In one exemplary embodiment, the digital building operating system Di-BOSS 127 aggregates energy consumption data from a variety of sensors within the building. These sensors can include but are not limited to a building electrical meter, a building steam meter, a tenant electrical submeter, and a tenant steam submeter. In the exemplary embodiment, the building is coupled to a district heating system that provides steam to the building for heating purposes. However, the EMS 227 can also be coupled with other types of energy consuming services, such as where the building is heated by a petrochemical, such as oil or natural gas for example. Where the oil or natural gas or any other fuel is used to heat water into steam, an appropriate meter would be coupled to measure the amount of steam being consumed.

In an exemplary embodiment, the Di-BOSS 127 can receive sensor data, from multiple sites powered from multiple substations, measuring space temperatures, electric voltage, frequency and phases of low voltage end-user electrical equipment, steam, water and natural gas consumption, or the like. The Di-BOSS 127 can connect to a novel Machine Learning System for monitoring and determining the prediction of impending dangerous and maintenance events such as electric grid disturbances such as blackouts, and which in turn can connect automatically to an alarming and alerting system that prevents harm to occupants of all kinds. In one example, alarms can go to the BMS 143 of one building if the event is determined to be of local causes, or to multiple building operating systems and to the utility and city/state if the event appears to be a regional or national disturbance about to happen. In one exemplary embodiment, the Di-BOSS 127 includes a Total Property Optimization (TPO) management cockpit 243 that receives subsystem inputs 163, 165, 167, 169, 171, 173, 143, 161, 217, 221, 223, 225, 227, 229, 231 from building subsystems and also external inputs 151, 153, 155, 157, 201, 203, 205, 207, 209. In response to these inputs, the TPO property management cockpit 243 can provide a machine learning derived forecast of outputs, including a display 211 and operational outputs.

In an exemplary embodiment, external inputs to the digital building operating system Di-BOSS 127 can include, but are not limited to, a utility grid status (UGS) 233, weather prediction data 213 and historical data 215 related to the building performance data, or the like. The UGS 233 is a real time Power Quality status indicator that the Di-BOSS 127 can receive from the electrical power supplier, such as the electrical utility. The UGS 233 can provide an advanced warning to the building operator of the operational status or health of the external electrical grid. Through the UGS 233, the utility can signal to the Di-BOSS 1271 issues that can impact the operations of building. In response to the UGS 233 signal, the Di-BOSS 127 or building manager can institute actions in advance of a loss of power, for example, automatically communicating to the Elevator Management system to send elevators to safe evacuation floors.

The weather forecast can be a major factor in the operation of the HVAC systems in a building. The weather prediction 213 data can include, but is not limited to, a forecast of expected weather in the area of the building for a desired time period, such as the following day for example. In one example embodiment, the weather prediction 213 data can be used by the Di-BOSS tem 127 as one variable to determine the pre-start time for initiating the HVAC system of building in winter. Weather prediction 213 data can also include a longer range forecast, such as a week or month forward, for example, to allow the Di-BOSS 127 to forecast expected energy consumption over that prediction interval. In this manner, the building manager can determine if adequate fuel is on site for operations and emergencies.

In the exemplary embodiment, the historical data 215 can be a database that stores information collected by the digital building operating system Di-BOSS 127. The historical data 215 allows the control center to provide a comparison of the current real-time operating parameters with past operating conditions from similar circumstances. In one embodiment, the historical data 215 can include demand profile curve data for energy usage and building performance data. The building performance data can include at least actual weather data (temperature, cloud cover, relative humidity), pre-start initiation time, startup time and machine learning (ML) derived rampdown time in the afternoon driven by data on occupancy over time.

It should be appreciated that the historical data 215 can be physically stored in one relational or multiple databases as is know in the art. Further, in one embodiment, the historical data 215 includes manufacturer data for the subsystems within the building.

The digital building operating system Di-BOSS 127 can also include a number of operational outputs. These operational outputs include, but are not limited to, tenant data 201, usage or demand and consumption reports 203, weather normalization 205, building pre-start and start times 207, and occupancy dominated rampdown time or occupancy normalization 207, or the like. In one example, building personnel in assessing the operation of the building can use some of these outputs, such as electrical and steam usage reports 203. It should be understood that the usage reports can also be understood as a demand and consumption report 203. The usage reports 203 can generate graphic and text reports automatically as part of Di-BOSS 127 for demand and consumption history and comparisons of those values versus actual real-time performance across variable time periods. Usage reports 203 can also provide tabular or graphical representations of other operations data for the building. Other outputs from the control center 115, such as weather normalization 205 for example, can be used to adjust alarms and change set point parameters in the buildings subsystems.

In one exemplary embodiment, other operational outputs can be used as an input to one or more building subsystems. In one example, the weather normalization 205 can integrate weather data 213 (real-time and predicted) to adjust alarm or set point parameters. The building pre-start time 207 can use data such as weather prediction information 213 (temperature, RH, cloud cover) and historic data 215 performance under similar conditions. The system can predict a recommended building systems pre-start time 207 (e.g. the time of day to start warming or cooling the building) in order to reach a desired indoor environment level by a predetermined point in time while minimizing operating time. Similarly, occupancy normalization 209 can allow the Di-BOSS 127 to integrate the current occupancy levels (based on vacant space) to adjust alarm parameters.

### Exemplary Machine Learning Performed by Digital Building Operating System

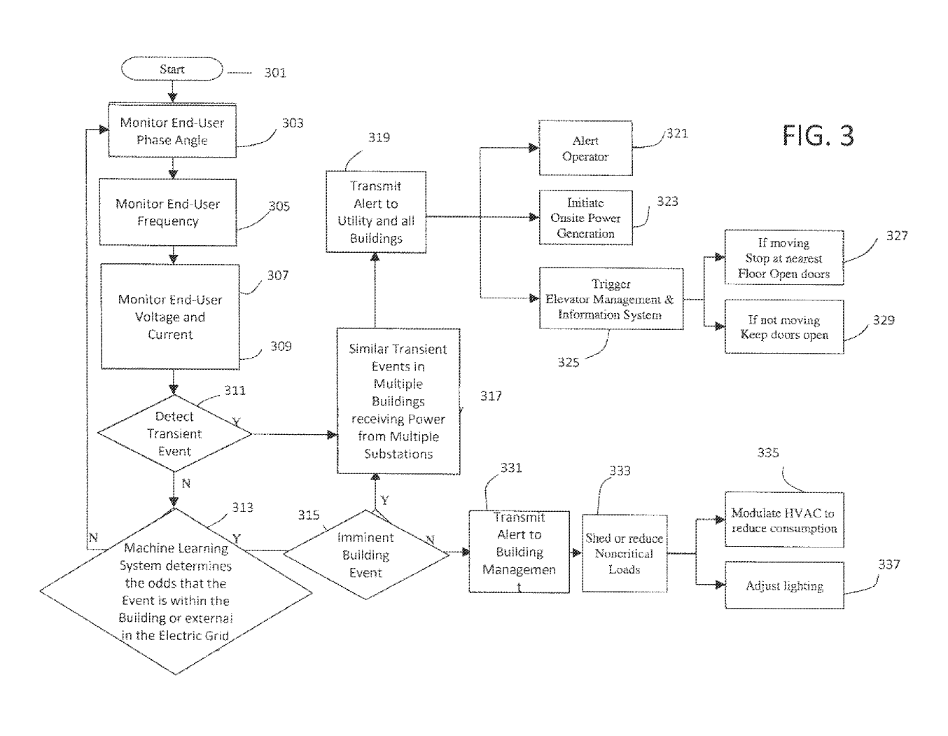

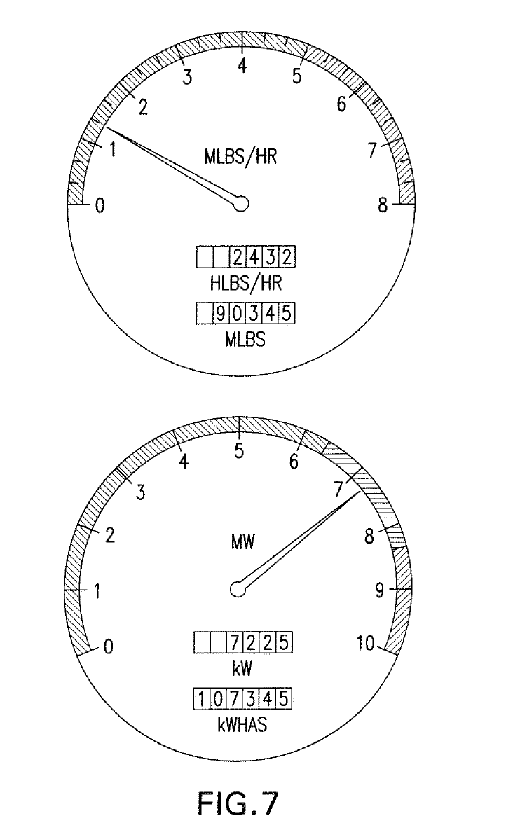

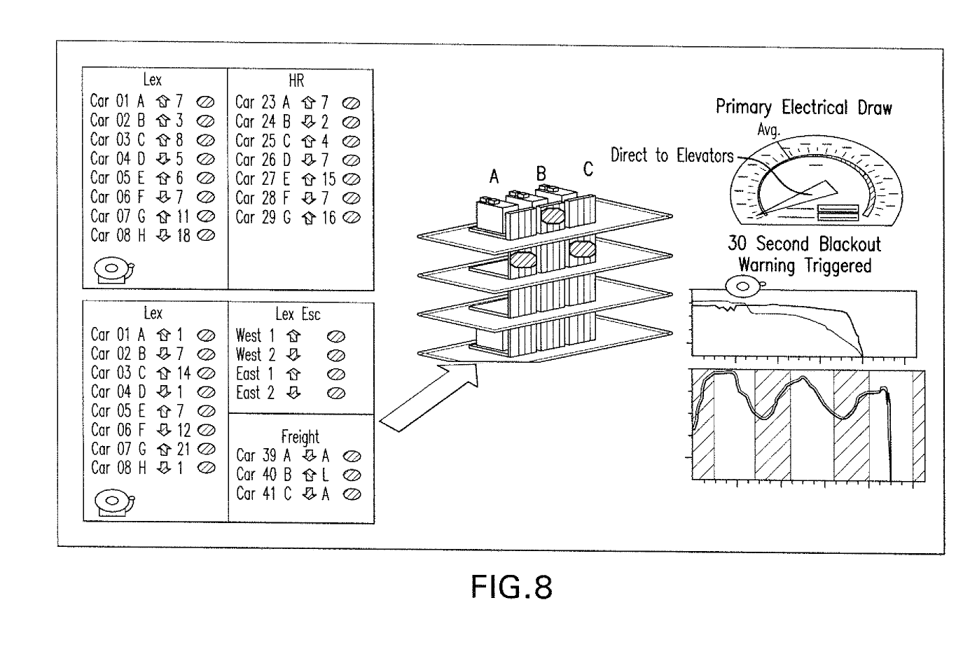

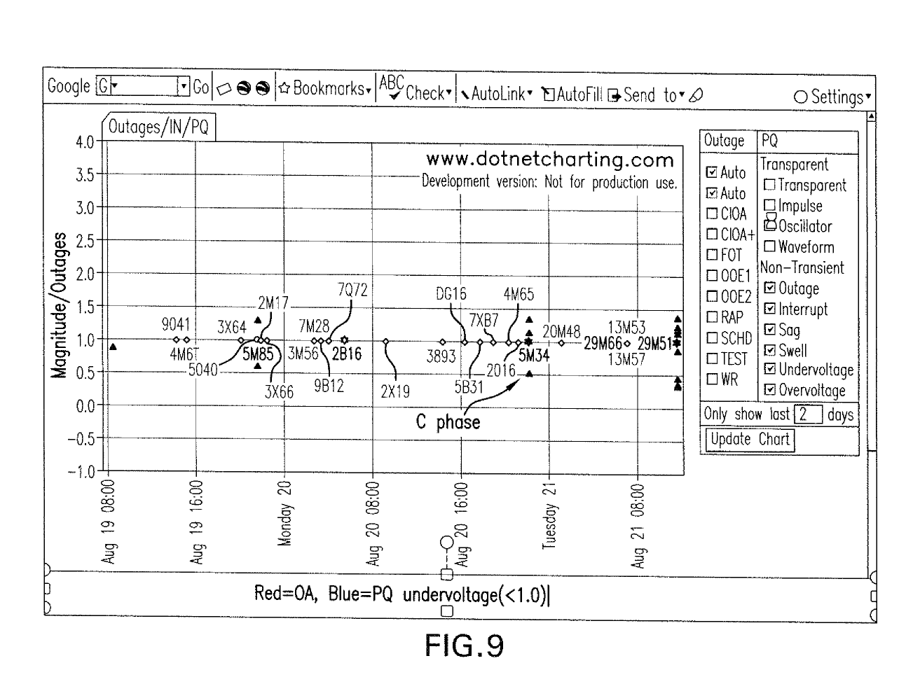

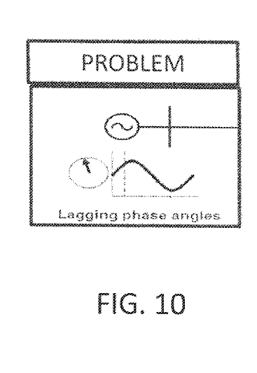

FIG. 3 illustrates an exemplary logic diagram of simultaneous monitoring performed by the digital building operating system Di-BOSS 127. FIG. 3 illustrates an exemplary method performed by the Power Quality 241 unit of the Di-BOSS 127. The method illustrates an exemplary process of using an operational output as an input to a building subsystem. In this embodiment, the Di-BOSS 127 can receive inputs and monitor the end-user phase angle 303, the end-user frequency 305, the end-user voltage and current 307. The Di-BOSS 127 then detects transient event 311 and the machine learning system for the Power Quality 241 determines the odds that the event is within the building or external in the Electric grid 313. The Di-BOSS 127 then determines if the building event is imminent 315 and if it is then analyzes if similar transient events in multiple building are receiving power from multiple substations 317. The Di-BOSS 127 then transmits alert to utility and all buildings 319. The Di-BOSS 127 then alerts the operator 321, initiates onsite power generation 323, and triggers elevator management and information system 325. The Di-BOSS 127 can also if the elevator is moving, stop the elevator at the nearest open door 327 and if the elevators are not moving, keep the doors open 329. The Di-BOSS 127 can also transmit alert the the building management system 143 if the building event is not imminent 315. The building as a result can shed or reduce noncritical loads 333 and modulate the HVAC to reduce consumption 335 or adjust lighting 337. FIG. 9 illustrates an exemplary display when an event is detected by the machine learning system of the Di-BOSS 127. FIG. 10 illustrates an exemplary display when an electrical power quality problem is detected by the Di-BOSS 127 system.

### Exemplary Displays of the Digital Building Operating System

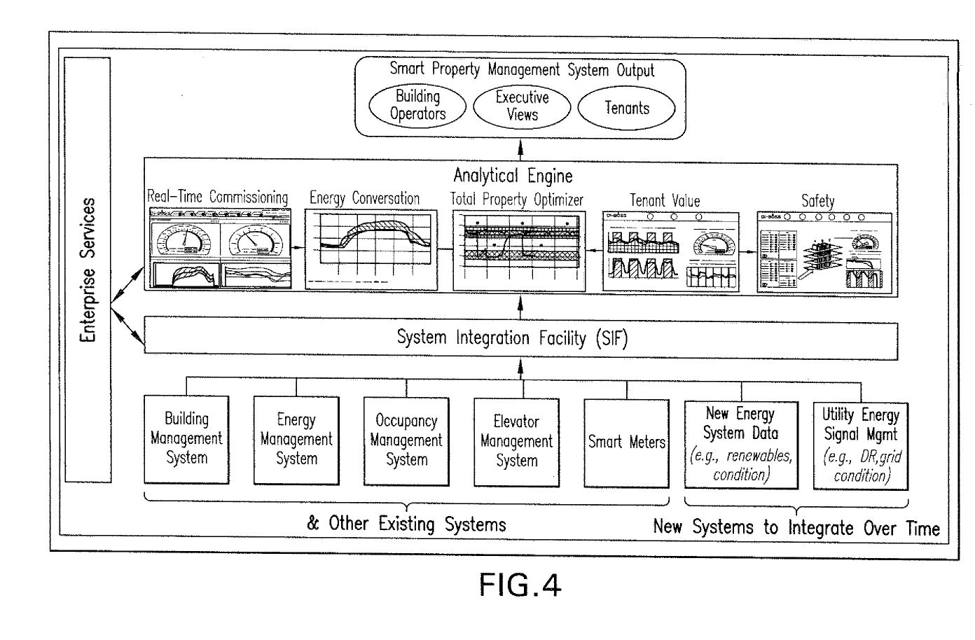

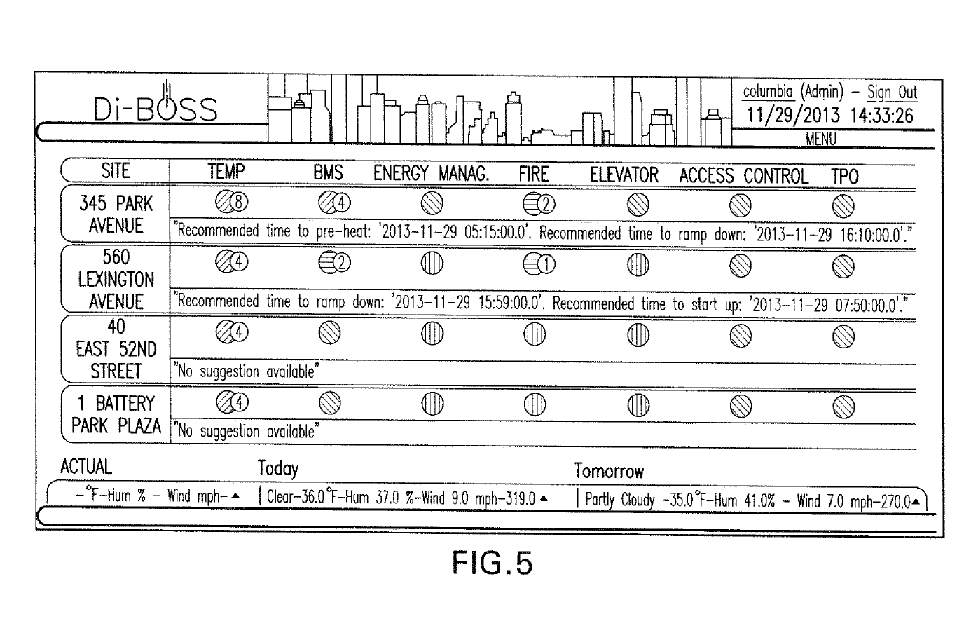

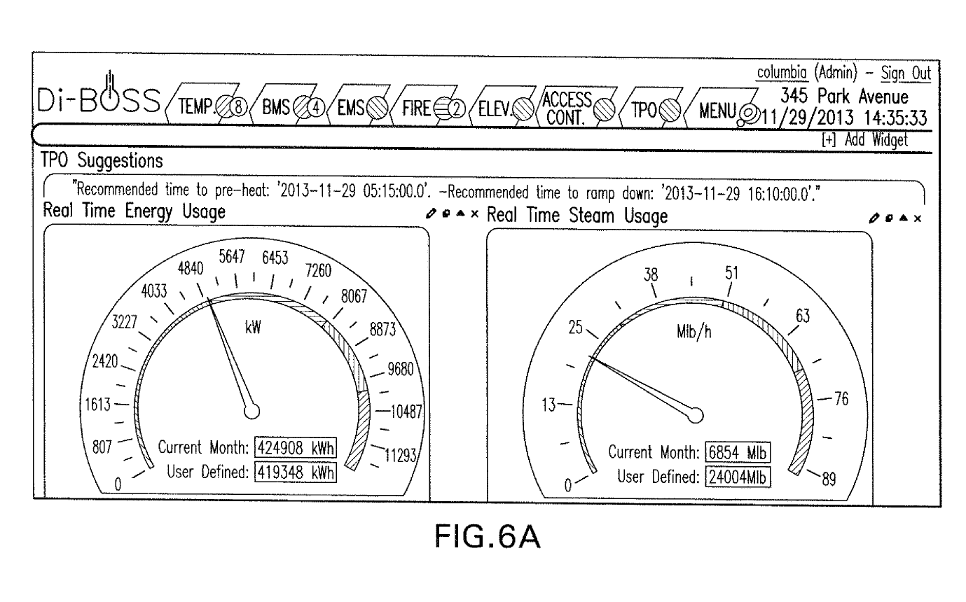

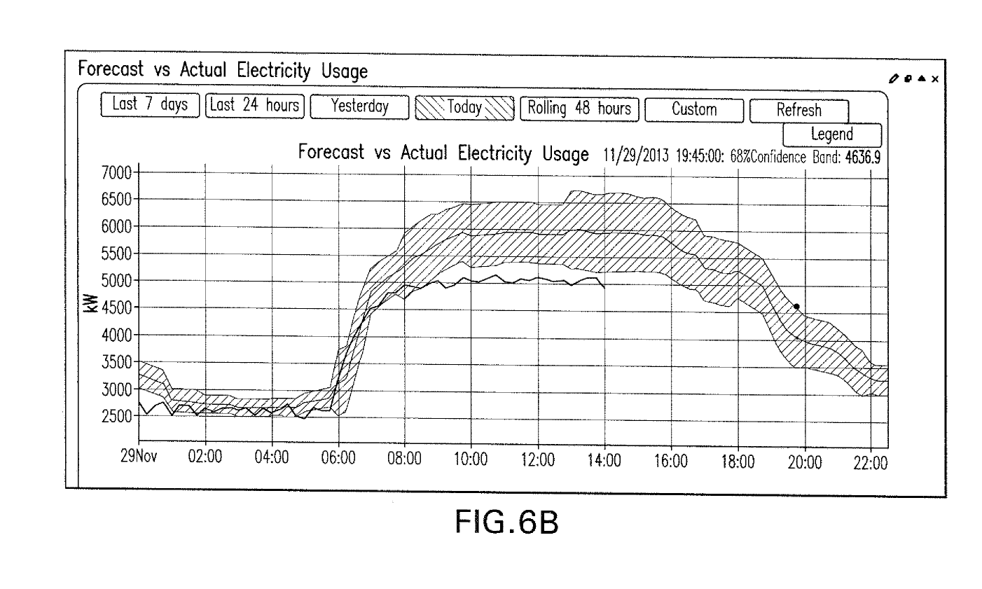

FIG. 4, FIG. 5, FIG. 6A, FIG. 6B, FIG. 7, FIG. 8, FIG. 9, and FIG. 10 provide exemplary displays 211 for the digital building operating system Di-BOSS 127. In one embodiment, each tenant within the building can have a tenant fractal management cockpit as illustrated in FIG. 4. The tenant fractal management cockpit can provide the tenant with data relevant to their operation. The tenant fractal management cockpit can receive tenant data 201 from the BMS 143. In one embodiment, the tenant data 201 is a subset of the overall data received by the BMS 143. The tenant data 201 can also be data that is converted into a form more relevant to the tenant, such as energy consumption in dollars per hour instead of BTU per hour, for example. In one embodiment, the BMS 143 can include appropriate controls and security to prevent tenant data 201 from being transmitted to the wrong entity.

In one exemplary embodiment, the Di-BOSS 127 can also includes a display that can provide a real time status indication to the building manager. One embodiment of display is illustrated in FIG. 5, FIG. 6A, FIG. 6B, FIG. 7, and FIG. 8. In this embodiment, the display can include a gauges portion (as illustrated in FIG. 6A) and an indicator portion (as illustrated in FIG. 5). As illustrated in FIG. 8, In one embodiment, the display can be an output of the EMS 229 and can be used to highlight data collected from field devices (i.e. sub-metering building and tenant systems). In this embodiment, the display is present as the desktop background of the building manager's general-purpose computer monitor. The display can be visible to the building manager regardless of the current program in use. This can provide advantages over previous subsystem controls that require the building manager to actively seek out information by going to specific locations to find data.

In one exemplary embodiment, the gauges portion (as illustrated in FIG. 6A and FIG. 7) of Di-BOSS 127 can be a graphical representation of an analog gauge (as illustrated in FIG. 5). This can enable the building manager to ascertain the status of the parameter being measured at a glance without having to specifically focus on the gauge. In the exemplary embodiment, the gauges portion (as illustrated in FIG. 6A and FIG. 7) can include a first gauge 701 and a second gauge 703. In one example, the first gauge 701 can output real time electrical demand and consumption information for the building. In another example, the first gauge 701 can include a needle indicator 778 that is rotated to point at the current level of electrical consumption. The first gauge can further include operating ranges 780, 782, 784. The operating ranges 780, 782, 784 can be color coded to define a normal operating range 780 and a high consumption range 782. For example, operating range 780 can be colored green to indicate an acceptable level of consumption, while operating range 782 can be colored yellow to indicate that consumption is high, while operating range 784 can be colored red to indicate that consumption is unacceptably high and the building manager can take actions to reduce electrical usage. In one example embodiment, the operating ranges 780, 782, 784 can change on a periodic basis to, for example, reflect expected operations based on historical data 215 and weather prediction data 213. In another embodiment, the operating ranges can be operator definable.

As further illustrated in FIG. 7, the first gauge 701 of Di-BOSS 127 can further include a digital readout 786 that displays the current power demand in kilowatts (KW) or the like. A second digital readout 788 can display consumption measured in kilowatt hours (KWhr) or the like. The readout 788 can be reset by the operator to, for example, display real time KWhr consumed on an annual, monthly, weekly, or 24 hour basis. In one embodiment, the BMS 143 can be configured with alarm notifications, including but not limited to audible, visual, email, instant message and text message for example, for notifying the building manager when consumption or demand levels on first gauge 701 are approaching or projected to approach an undesired operating range. In another embodiment, emails can also be sent to next tier property managers.

As further illustrated in FIG. 7, in an exemplary embodiment, the second gauge 703 of Di-BOSS 127 can be an indicator of real time fuel (steam, oil, natural gas) demand and consumption. In the exemplary embodiment, the second gauge 703 can indicate the consumption of steam from a district heating system. The second gauge 703 can include a representation of an analog needle indicator 790 that points to the current steam demand as measured, for example, in thousands of pounds per hour (mlbs/hr). Similar to the first gauge 701, the second gauge 703 can also include operating ranges 780, 782, 784 that provide a visual cue to the operating state of steam consumption.

As further illustrated in FIG. 7, the second gauge 703 of Di-BOSS 127 can include a first digital readout 796 indicating the current steam demand in incremental units appropriate for the historical demand of the heating plant (for example, mlbs/hr). A second digital readout 798 can provide an indication of consumption, in units appropriate for the heating plant history that will display consumption on an annual, monthly, weekly, or daily basis. In one embodiment, the BMS 143 can be configured with alarm notifications, including but not limited to audible, visual, email, instant message and text message for example, for notifying the building manager when consumption or demand levels on first gauge 701 are approaching or projected to approach an undesired operating range, such as operating range 784 for example. In another embodiment, emails can also be sent to next tier property managers

As further illustrated in FIG. 4 and FIG. 5, the indicator portion of Di-BOSS 127 can include a plurality of discrete indicators each associated with one of the subsystem inputs. These can include, for example, a FACS 217 indicator, BMS 143 indicator, EMIS 221 indicator, EMS 227 indicator, ACS 223 indicator, and SCADA 225 indicator. Each indicator can include an adjacent label portion providing a description of the indicator. The indicator portion can also include additional indicators, such as an UGS 231 indicator, as desired by the building manager. As further illustrated in FIG. 5, In the exemplary embodiment, the indicators of Di-BOSS 127 can be color coded to provide the building manager with a snapshot of the operational status of the building without having to focus on the indicator portion. In one embodiment, the indicators are green when a subsystem is operating normally, yellow when a parameter is within operating parameters but outside the expected range, and red when a parameter is outside the desired operating range.

In the exemplary embodiment, the portions of the digital building operating system Di-BOSS 127 displays seen in FIG. 4, FIG. 5, FIG. 6A, FIG. 6B, FIG. 7, FIG. 8, FIG. 9, and FIG. 10 can be selectable or clickable by the building manager using a user interface, such as a mouse, when the building manager desires more information. In one embodiment, by selecting a part of the portions the Di-BOSS 127 can allow the building manager to drill down into the data underlying the selected gauge or indicator. In one embodiment, the selection of the gauge or indicator executes the usage reports 203 that are appropriate for the selection.

In an exemplary embodiment, a version of the Di-BOSS 127 display seen in FIG. 6A and FIG. 6B can be made available to tenants on the tenant management cockpit by transmitting the same, but filtered, real time and historical data to the end users office computer. The information can be formatted in metrics relevant to the tenant or end user. For example, instead of readout of kilowatts per hour, the gauge can read dollars/cents per hour and would provide advantages in incentivizing load reduction and energy conservation.

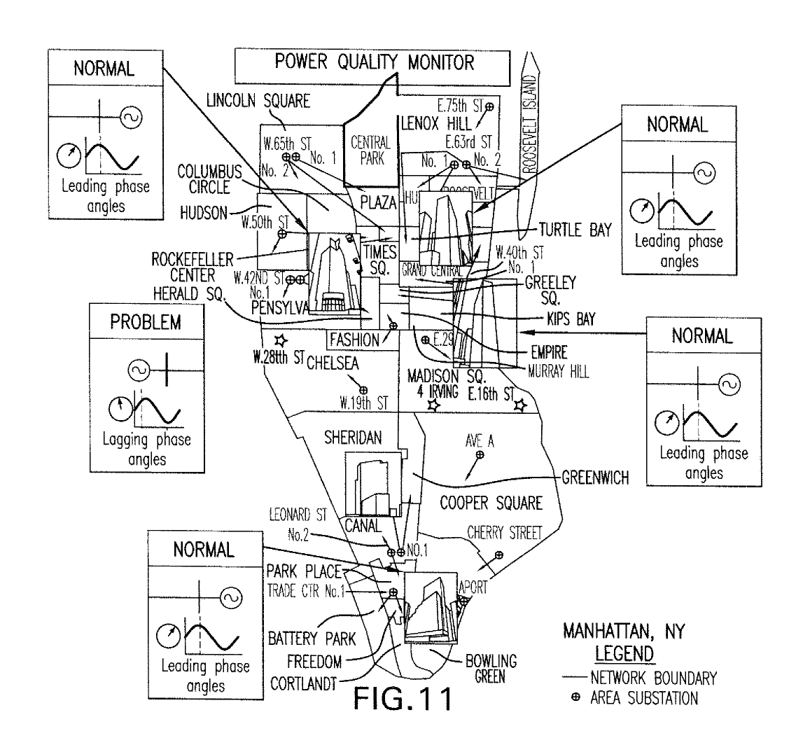

Referring now to FIG. 11, an exemplary system embodiment of Di-BOSS 127 having multiple buildings 117, 119 or multiple properties is illustrated. A building owner or a building manager can be in one location and be responsible for several, sometimes geographically distant, buildings or properties.

Each of the individual buildings 117, 119 in the Di-BOSS 127 cockpit has a BMS 143 that is substantially similar to the system described herein. Each of the BMS 143 in the buildings can be coupled to a master property management cockpit or a Di-BOSS 127 by a communications medium. The communications medium can be any known communication medium, including but not limited to a wide area network (WAN), a public switched telephone network (PSTN) a local area network (LAN), a global network (e.g. Internet), a virtual private network (VPN), and an intranet. The communications network 120 can be implemented using a wireless network or any kind of physical network implementation known in the art. The individual BMS 143 in each building can be coupled to the property management cockpit in Di-BOSS 127 through multiple networks (e.g., intranet and Internet) so that not all individual BMS 143 are coupled through the same network. Furthermore, the individual BMS 143 can be connected to the property management cockpit of Di-BOSS 127 by a combination of a PSTN and the Internet, for example. One or more of the individual building property management cockpits of Di-BOSS 127 can be connected to the communications medium in a wireless fashion.

In the exemplary embodiment, the Di-BOSS 127, BMS 143 can include a display substantially similar to displays described in FIG. 4, FIG. 5, FIG. 6A, FIG. 6B, FIG. 7, FIG. 8, FIG. 9, and FIG. 10. The Di-BOSS 127 gauges for BMS 143 can display either total amounts from all of the buildings 117, 119, or data for individual buildings 117, 119. In this manner, the property manager can track the total consumption of all the buildings they manage, which can provide advantages monitoring compliance with long term service contracts that property manager executes with energy suppliers.

In this manner, for example, the digital building operating system Di-BOSS 127 can further be adapted to identify the location of a pending failure event as well using triangulation techniques. For example, if a first customer and a second customer share a substation, and a third customer is connected to a different substation, sensor data can cause the Di-BOSS 127 to predict a localized failure event for the first and second customer only, but not for the third customer, and the Di-BOSS 127 can indicate that the coming failure event is located at a node along the distribution network associated with the first substation. If however, the Di-BOSS 127 can detect that multiple buildings connected to multiple substations are recording similar signals that indicate an impending regional power failure, the Di-BOSS 127 can send alarms not only to the various building managers, but also to the utility. Additionally, for example, a failure event associated with a particular customer can be identified, as sensor data for that particular customer can indicate a failure event within that building only, while sensor data for other customers can indicate a normal mode of operation.

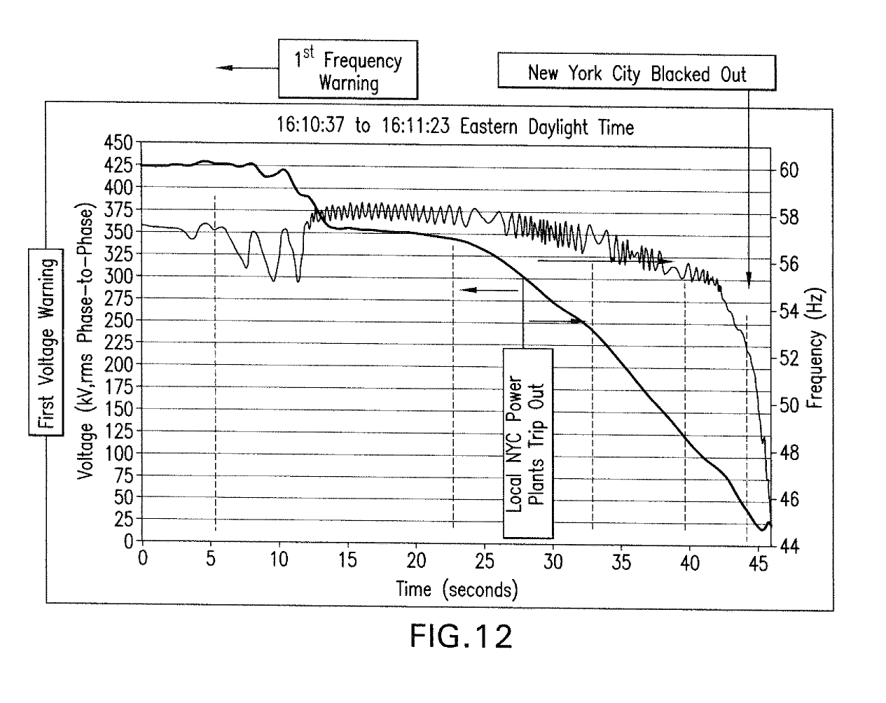

FIG. 12 illustrates an exemplary electric power quality measurement to detect a potential blackout. Electric power quality can be measured as a time series looking for out-of-normal frequencies and voltages of the electric grid such as that detected before the Northeastern Blackout of 2003. As illustrated in FIG. 12, these measurements were made at different locations and not transmitted to the Di-BOSS 127 and so were not identified to be synchronous until after the blackout had occurred.

Additionally or alternatively, machine learning or heuristic systems, for example, support vector machine regression, can be used to identify the type and location of an impending failure event and evaluate the statistical level of confidence that the event will happen. Such machine learning or heuristic systems such as the Total Property Optimization (TPO) management cockpit 243 can also balance the likelihood of a failure event type and location with the costs and benefits and risks of taking remedial action should it turn out to be a false-positive event and transmit that decision to the Di-BOSS 127 cockpit.

In an exemplary embodiment, measurements can be taken within the transmission and distribution grid, for example, as disclosed in U.S. application Ser. No. 12/909,022 (which is incorporated herein by reference in their entirety), and within low-voltage locations, such as commercial office buildings. Measurements from the utility-side and measurements from the end-user-side can be mutually communicated between the utility control center and the digital building operating system Di-BOSS 127 to provide for enhanced detection of network instability.

One of ordinary skill in the art will appreciate that various approaches can be used to sense local measurements, monitor and detect out-of-normal operating conditions, and provide alarms that predict whether each new problem is utility grid related or internal to the building. A statistical evaluation of the risk can accompany each early warning alarm so that the utility and/or end-user can determine whether to take actions based on the odds. For example, measurement systems can be placed in buildings that are electrically diverse within the distribution system. Measurement devises can be placed at several locations that sense enough of the high voltage transmission system and internal feeds in the building to determine whether the problem is internal to the building housing the sensors, in the local utility distribution grid, or a system-wide transmission grid anomaly, and the control center can communicate these interpretations to the appropriate locations so that actions can be taken prior to the failure. The system can further include techniques to differentiate between anomalies in the high voltage transmission grid, local utility distribution supply or internal building distribution problems that can create similar voltage, phase angle and frequency anomalies.

An embodiment of the disclosed subject matter can be embodied in the form of computer-implemented processes and apparatuses within the digital building operating system Di-BOSS 127 for practicing those processes. The disclosed subject matter can also be embodied in the form of a computer program product having computer program code containing instructions embodied in tangible media, such as CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the disclosed subject matter. The disclosed subject matter can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the disclosed subject matter. When implemented on a general-purpose microprocessor, the computer program code segments configure the microprocessor to create specific logic circuits. A technical effect of the executable instructions is to manage energy consumption and monitor operational status of subsystems within a building using the digital building operating system Di-BOSS 127.

While the disclosed subject matter has been described in detail in connection with only a limited number of embodiments, it should be readily understood that it is not limited to such disclosed embodiments. Rather, the disclosed subject matter can be modified to incorporate any number of variations, alterations, substitutions or equivalent arrangements not heretofore described, but which are commensurate with its spirit and scope of.

We claim:

1. A system for monitoring status of an electrical grid and one or more building subsystems, the system comprising:
one or more sensors in communication with the electrical power grid, adapted to provide data;
one or more buildings, adapted to provide data related to the one or more building subsystems;
a digital building operating system, adapted to receive data from the one or more sensors and the one or more buildings, the digital building operating system further comprising:
one or more processors, each coupled to and having respective communication interfaces to receive data, the one or more processors executing computer-readable instructions that, when executed by the processor, cause the one or more processors to perform:
processing the data from the electrical grid and the one or more buildings;
identifying status of the electrical grid and the one or more building subsystems based on the data;
predicting one or more events based on the data; and
providing
(i) one or more instructions to the one or more buildings based on the status of the electrical grid and the one or more building subsystems and
(ii) the prediction of the one or more events.

2. The system of claim 1, wherein the one or more sensors are low-voltage end-user side of a secondary distribution network.

3. The system of claim 1, wherein the data includes one or more of frequency, phase angle, and voltage.

4. The system of claim 1, wherein the data is representative of geographically distributed customers in one or more locations.

5. The system of claim 1, wherein the predicting of the one or more events further comprises one or more of instability of the electrical grid, blackout, power failures, and blackouts or low voltage and frequency brownouts.

6. The system of claim 5, wherein the predicting of the one or more events further comprises identifying the location of the grid instability.

7. The system of claim 6, wherein the system identifies the location of the grid instability using one or more triangulation techniques.

8. The system of claim 1, wherein the system uses mathematical and statistical techniques such as machine learning and adaptive stochastic control.

9. The system of claim 1, wherein the digital building operating system is comprised to provide one or more actions based on the status of the electrical grid.

10. The system of claim 1, wherein the instructions further cause the processor to perform:
monitoring the status of the one or more buildings;
identifying one or more events in the the one more buildings;
determining if the event is related to the electrical grid or the one or more buildings; and
providing instructions to the one or more building based on the determination.

11. The system of claim 1, wherein the instructions include one or more of shutting down the elevator of the one or more buildings, adjusting lighting, keeping elevator doors open, modulating HVAC to reduce consumption.

12. A method for monitoring status of an electrical grid and one or more building subsystems, the method comprising:
receiving data from one or more sensors in communication with the electrical grid and one or more buildings;
processing the data from the electrical grid and the one or more buildings;
identifying status of the electrical grid and the one or more building subsystems based on the data;
predicting one or more events based on the data; and
providing
(i) instructions to the one or more buildings based on the status of the electrical grid and the one or more building subsystems and
(ii) the prediction of the one or more events.

13. The method of claim 12, further comprising predicting if the electrical grid is unstable based on the data from the one or more sensors.

14. The method of claim 13, further comprising predicting whether the outcome of the grid instability is one or more of a brown out, a power outage, or a momentary service outage.

15. The method of claim 13, further comprising using cost and benefits to determine whether to take one or more actions.

16. The method of claim 13, further comprising the location of the grid instability using one or more triangulation techniques.

17. The method of claim 12, further comprising identifying if a instability of the grid is due to the electrical grid or the one or more buildings.

18. The method of claim 12, further comprising generating a metric representative of prediction that identified status of the electrical grid is about to result in imminent power failure.

19. The method of claim 12, wherein the data includes one or more of frequency, phase angle, and voltage.

20. The method of claim 12, further comprising mathematical and statistical techniques such as machine learning and adaptive stochastic control to determine the status of the grid.

21. The method of claim 12, further comprising performing one or more actions based on the status of the electrical grid.

22. The method of claim 12, further comprising communicating with a building digital building operating system.

23. A system for monitoring status of an electrical grid and one or more building subsystems, the system comprising:
the one or more of building subsystems of one or more buildings, each of the one or more building subsystems having an associated control system;
at least one relational database, said database having data related to a building;
a display;
a controller operably coupled to and in communication with the one or more building subsystems, the at least one relational database and the display, the controller having a processor responsive to executable computer instructions when executed on the processor for:
monitoring the status of the electrical grid and the one or more building subsystems based on data from the one or more building subsystems and said at least one relational database;
predicting one or more events based on data from the one or more building subsystems and the at least one relational database;
providing instructions based on the monitoring of the status of the electrical grid and the one or more building subsystems and the prediction of one or more events; and
displaying a graphical representation on the display indicating one or more of a consumption level of energy of at least one of the one or more building subsystems, and a status of one of the one or more building subsystems.

24. The system of claim 23, wherein the display enables remote monitoring of the one or more building subsystems.

25. The system of claim 23, wherein the system further monitors one or more of (i) space temperatures, (ii) building management systems, (iii) heating, ventilatiion, and air conditions, and (iv) fire and occupancy tracking control systems of the one or more buildings.

26. The system of claim 23, wherein the one or more buildings comprises one or more sensors to provide the data related to the building.

27. The system of claim 23, wherein the one or more events relates to power quality.

28. The system of claim 23, wherein the system further predicts whether the outcome of the grid instability is one or more of a brown out, a power outage, a variation in power quality, phase angle, or a momentary service outage.
